(19) United States
(12) Patent Application Publication
(10) Pub. No.: US 2026/0303572 A1
(43) Pub. Date: Oct. 1, 2026

(54) TRAFFIC MANAGEMENT OF VIRTUAL PRIVATE NETWORK TRAFFIC

(71) Applicant: Sophos Limited, Abingdon Oxfordshire (GB)

(72) Inventors: Vamshi Krishna DOMMETI, Bangalore (IN); Nishit SHAH, Ahmedabad (IN); Jigar Bhupatbhai BHAT, Ahmedabad (IN)

(73) Assignee: Sophos Limited, Abingdon Oxfordshire (GB)

(21) Appl. No.: 19/287,342

(22) Filed: Jul. 31, 2025

(30) Foreign Application Priority Data
Mar. 29, 2025 (IN) 202511031134

(51) Int. Cl. H04L 9/40; H04L 45/7453

(52) U.S. Cl. CPC H04L 63/0272; H04L 45/7453; H04L 63/0236

(57) ABSTRACT

A computer-implemented method includes receiving data traffic at a network device from an endpoint device over a virtual private network tunnel established between the endpoint device and the network device, wherein the data traffic includes a source-destination tuple that comprises a source gateway IP address and a destination gateway IP address. The method further includes determining, at a network layer, whether the source-destination tuple matches a reference source-destination tuple of a plurality of reference source-destination tuples, wherein individual reference source-destination tuples comprise a respective reference source gateway IP address and a respective reference destination gateway IP address, based on a determination that the source-destination tuple matches the reference source-destination tuple, accepting the data traffic for onward transmission to a protocol layer of the network device, and based on a determination that the source-destination tuple does not match any reference source-destination tuple, rejecting the data traffic at the network layer.

### CROSS-REFERENCE TO RELATED APPLICATIONS

This application claims priority to Indian Patent Application No. 202511031134, entitled, “Traffic Management of Virtual Private Network Traffic,” filed Mar. 29, 2025, which is incorporated herein by reference in its entirety.

### TECHNICAL FIELD

Embodiments relate generally to traffic management in virtual private networks. More particularly, embodiments relate to methods, systems, and computer readable media to perform efficient verification of a source gateway internet protocol (IP) address and destination gateway IP address tuple with reference source gateway IP addresses and destination gateway IP addresses at the kernel level.

### BACKGROUND

As enterprise networks become more complex, and security threats become more sophisticated, there remains a need for improved techniques for compact, timely delivery of security events on endpoints and within an enterprise network.

Virtual private network (VPN) tunnels are secure pathways utilized in networks to enable data to be transmitted privately and securely between a user device and a VPN server, concealing the IP address of the user device, and encrypting data traffic to and from the user device.

In networks that support large numbers of VPN tunnels, bringing up the VPN tunnels can cause a slowdown in network devices. During data transmission subsequent to establishment of a VPN tunnel, verifying IP addresses of endpoint/gateway tuples associated with each data transmission (e.g., a data packet) in a sequential manner can delay acceptance of the data traffic.

The background description provided herein is for the purpose of presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### BRIEF DESCRIPTION OF THE DRAWINGS

The foregoing and other objects, features, and advantages of the devices, systems, and methods described herein will be apparent from the following description of particular embodiments thereof, as illustrated in the accompanying drawings. The drawings are not necessarily to scale, emphasis instead being placed upon illustrating the principles of the devices, systems, and methods described herein.

FIG. 1 depicts a block diagram of a threat management system, according to some embodiments described herein.

FIG. 2 depicts a block diagram of a threat management system, according to some embodiments described herein.

FIG. 3 shows a system for enterprise network threat detection, according to some embodiments described herein.

FIG. 4 illustrates a threat management system, according to some embodiments described herein.

FIG. 5 depicts a block diagram of a firewall that is utilized to manage traffic between a source gateway and a destination gateway, according to some embodiments described herein.

FIG. 6A is a block diagram that depicts example objectives of traffic management of VPN traffic by a firewall, according to some embodiments described herein.

FIG. 6B depicts example commands utilized for traffic management of VPN traffic by a firewall, according to some embodiments described herein.

FIG. 7 is a sequence diagram that depicts traffic management of VPN traffic by a firewall, according to some embodiments described herein.

FIG. 8 illustrates an example method for management of traffic in a virtual private network (VPN), according to some embodiments described herein.

FIG. 9 illustrates an example method for matching a source-destination tuple with a reference source-destination tuple, according to some embodiments described herein.

FIG. 10 illustrates an example method for insertion of a source-destination tuple into a hash table, according to some embodiments described herein.

FIG. 11 illustrates an example method for deletion of a source-destination tuple from a hash table, according to some embodiments described herein.

FIG. 12 is a block diagram of an example computing device, according to some embodiments described herein.

### DESCRIPTION

Embodiments will now be described with reference to the accompanying figures. The foregoing may, however, be embodied in many different forms and should not be construed as limited to the illustrated embodiments set forth herein.

All documents mentioned herein are hereby incorporated by reference in their entirety. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately” or the like, when accompanying a numerical value, are to be construed as indicating a deviation as would be appreciated by one of ordinary skill in the art to operate satisfactorily for an intended purpose. Similarly, words of approximation such as “approximately” or “substantially” when used in reference to physical characteristics, should be understood to contemplate a range of deviations that would be appreciated by one of ordinary skill in the art to operate satisfactorily for a corresponding use, function, purpose, or the like. Ranges of values and/or numeric values are provided herein as examples only, and do not constitute a limitation on the scope of the described embodiments. Where ranges of values are provided, they are also intended to include each value within the range as if set forth individually, unless expressly stated to the contrary. The use of any and all examples, or exemplary language (“e.g.,” “such as,” or the like) provided herein, is intended merely to better illuminate the embodiments and does not pose a limitation on the scope of the embodiments. No language in the specification should be construed as indicating any unclaimed element as essential to the practice of the embodiments.

In the following description, it is understood that terms such as “first,” “second,” “top,” “bottom,” “up,” “down,” and the like, are words of convenience and are not to be construed as limiting terms.

It should also be understood that endpoints, devices, compute instances, or the like that are referred to as “within” an enterprise network may also be “associated with” the enterprise network, e.g., where such assets are outside an enterprise gateway but nonetheless managed by or in communication with a threat management facility or other centralized security platform for the enterprise network. Thus, any description referring to an asset within the enterprise network should be understood to contemplate a similar asset associated with the enterprise network regardless of location in a network environment unless a different meaning is explicitly provided or otherwise clear from the context.

A traffic management system as described herein may be utilized to manage traffic between devices that are connected via a virtual private network (VPN). A VPN establishes a network connection between a user device and a remote server associated with a VPN provider. The remote server is an network device that includes a security application that creates a point-to-point tunnel (VPN tunnel) that encrypts data to and from the client device, masks an Internet Protocol (IP) address of the user device, and enables the user device to visit target servers (e.g., websites) without being tracked (since the user device network address is not transmitted to the target servers). VPN tunnels are additionally utilized to connect user device(s) to enterprise networks via the public internet, and to connect proprietary (private) networks via public (e.g., untrusted) networks.

A VPN tunnel between devices, e.g., a user device connecting from a remote site to an enterprise network device of an enterprise network, is secured by respective VPN gateways, e.g., a VPN gateway associated with the enterprise network and a remote site VPN gateway associated with a remote site. In some scenarios, an enterprise network may simultaneously support a plurality of VPN tunnels between devices, e.g., a plurality of remote computing devices connecting to an enterprise network via respective VPN tunnels.

Traffic over a VPN tunnel is secure, encrypted, and in some cases, may additionally be compressed. Establishment of a VPN tunnel involves creation of a secure and encrypted connection between two points (e.g., a user device and a VPN server) and may include selection of a suitable VPN protocol (such as IKEv2/IPSec protocol, OpenVPN, L2TP/IPSec, etc.), selection of a suitable compression technique, configuring software at both ends of the VPN tunnel, establishing authentication, setting up routing rules, etc. In some scenarios where multiple VPN tunnels are being established, bringing up the VPN tunnels (e.g., at boot time) sequentially can be a time consuming process, and in some cases, can overload the VPN server.

In some implementations, a network may enable a remote device to connect to the network via a VPN (e.g., IPsec) tunnel based on verification of a pre-shared key (PSK) for authentication or a security certificate (e.g., an RSA certificate) for authentication. In some implementations, a type of authentication may be based on a protocol and/or a configuration associated with the VPN tunnel. However, this can open up the network to potential vulnerabilities to unauthorized traffic since it may not be possible to assign static firewall rules to a connection, since the remote gateway IP address is unknown and variable.

To mitigate unauthorized access and apply firewall policies (e.g., access control layer (ACL) policies), gateway ACL chains may be utilized wherein a local gateway IP address and a remote gateway IP address are added to an iptable gateway ACL chain during establishment of a VPN tunnel. In some implementations, the gateway ACL chains are utilized to regulate data traffic, e.g., enable the bypassing of certain firewall policies for authenticated clients, protect the firewall from rogue clients, etc.

However, enforcement of the strict authentication and connection establishment policies by the firewall may be computationally demanding (e.g., require substantial processing power due to being CPU-intensive) and can overwhelm the firewall at high loads due to the need for performing lookups associated with decryption. For example, such lookups can include lookups of databases to ensure that only authenticated and established client devices are allowed to access the network. Accordingly, client devices (with or without compression enabled) are verified before data traffic from authorized client devices is accepted, while unauthorized and/or rogue clients are blocked to reduce and/or eliminate CPU loads and potential service disruptions. This approach ensures improved performance and security for the firewall and mitigates risks posed by unauthorized connections.

In some cases, data traffic, e.g., packet data, transmitted over a VPN tunnel may also undergo packet inspection at a firewall. Packet inspection may be based on network policies and rules that are specified for a connection. In some implementations, the rules may be installed during establishment of a VPN tunnel. In some implementations, the installation of rules may be performed via execution of an iptables command that specifies a respective VPN gateway IP address and a remote device IP address associated with a VPN tunnel, and rules that are to be applied to the VPN tunnel.

In some implementations, execution of the iptables command is performed by adding iptables rules for every client IP address and server IP address chain. However, serially adding and/or removing each iptable chain during VPN tunnel UP/DOWN processing can be relatively computationally intensive and can slow down the firewall processing.

In some scenarios, serialized execution of iptables commands to establish a plurality of VPN tunnels can cause high response times due to a high computational load being placed on the VPN server and/or firewall, e.g., during a time of tunnel bringup and/or tunnel bringdown. Additionally, sequential lookup of the iptable chains during data plane processing can potentially delay data traffic acceptance at the firewall.

Techniques described herein can be utilized to perform efficient traffic management of VPN tunnels. For example, gateway tuple lookups as described herein may be performed at a faster rate when performing gateway ACL chain processing based on hash lookups that are associated with a [O(1)] complexity when compared to sequential lookups, which are associated with an [O(n)] complexity. Additionally, the processing of the gateway ACL chains is performed within a kernel space of a firewall rather than in the user space of the firewall.

In some implementations, tuples constructed from corresponding source gateway IP addresses and destination gateway IP addresses are stored as a set (referred to as an IPset). Subsequently, a suitable command, e.g., an iptables command, may be issued with reference to the constructed set of tuples to perform lookups and operations on the sets directly rather than on individual tuples. Performing the operations on the sets directly, and within the kernel space can lead to savings in processing time and reduce a computational resource requirement associated with firewall processing for operations such as establishment of VPN tunnels, teardown of VPN tunnels, data plane processing of packet data, etc.

In some implementations, during data plane processing, IPset lookups may be performed based on a packet being received at one of a plurality of hooks (functions) that are registered with the kernel and which are to be called at specific points in a network stack implemented in the kernel. This can enable verification of a packet as soon as it is received at the hook (e.g., PREROUTING, INPUT, FORWARD, etc.) and enable unauthorized traffic to be dropped in the network layer of the network stack rather than in the protocol layer (transport layer within an OSI model), which enables faster processing, and reduces a load at the protocol layer.

In some implementations, further efficiencies may be realized by utilizing hash-based lookups to match a source gateway IP address and destination gateway IP address pair (source-destination tuple) with a set of reference source gateway IP addresses and reference destination gateway IP addresses (reference source-destination tuples). Utilization of hash-based lookups may provide superior performance in the data plane, and may avoid utilization of costly linear searches. In some implementations, the lookups may have a best-case complexity of O(1) and a worst-case complexity of O(N), where N is a number of reference source-destination tuples.

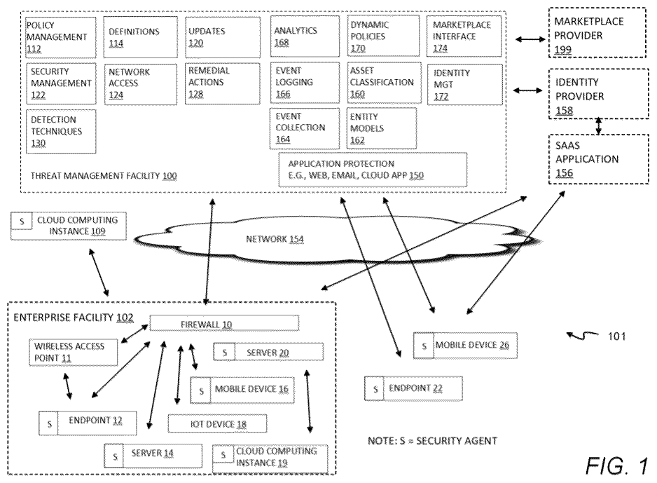

FIG. 1 depicts a block diagram of a threat management system, according to some embodiments described herein.

FIG. 1 depicts a block diagram of a threat management system 101 providing protection against a plurality of threats, such as malware, viruses, spyware, cryptoware, adware, Trojans, spam, intrusion, policy abuse, improper configuration, vulnerabilities, improper access, uncontrolled access, and more. A threat management facility 100 may communicate with, coordinate, and control operation of security functionality at different control points, layers, and levels within the system 101. A number of capabilities may be provided by a threat management facility 100, with an overall goal to intelligently use the breadth and depth of information that is available about the operation and activity of compute instances and networks as well as a variety of available controls. Another overall goal is to provide protection needed by an organization that is dynamic and able to adapt to changes in compute instances and new threats. In embodiments, the threat management facility 100 may provide protection from a variety of threats to a variety of compute instances in a variety of locations and network configurations.

Just as one example, users of the threat management facility 100 may define and enforce policies that control access to and use of compute instances, networks and data. Administrators may update policies such as by designating authorized users and conditions for use and access. The threat management facility 100 may update and enforce those policies at various levels of control that are available, such as by directing compute instances to control the network traffic that is allowed to traverse firewalls and wireless access points, applications and data available from servers, applications and data permitted to be accessed by endpoints, and network resources and data permitted to be run and used by endpoints. The threat management facility 100 may provide many different services, and policy management may be offered as one of the services.

Turning to a description of certain capabilities and components of the threat management system 101, an exemplary enterprise facility 102 may be or may include any networked computer-based infrastructure. For example, the enterprise facility 102 may be corporate, commercial, organizational, educational, governmental, or the like. As home networks get more complicated, and include more compute instances at home and in the cloud, an enterprise facility 102 may also or instead include a personal network such as a home or a group of homes. The enterprise facility's 102 computer network may be distributed amongst a plurality of physical premises such as buildings on a campus, and located in one or in a plurality of geographical locations. The configuration of the enterprise facility as shown is merely exemplary, and it will be understood that there may be any number of compute instances, less or more of each type of compute instances, and other types of compute instances. As shown, the exemplary enterprise facility includes a firewall 10, a wireless access point 11, an endpoint 12, a server 14, a mobile device 16, an appliance or IOT device 18, a cloud computing instance 19, and a server 20. Again, the compute instances 10-20 depicted are exemplary, and there may be any number or types of compute instances 10-20 in a given enterprise facility. For example, in addition to the elements depicted in the enterprise facility 102, there may be one or more gateways, bridges, wired networks, wireless networks, virtual private networks, other compute instances, and so on.

The threat management facility 100 may include certain facilities, such as a policy management facility 112, security management facility 122, update facility 120, definitions facility 114, network access rules facility 124, remedial action facility 128, detection techniques facility 130, application protection facility 150, asset classification facility 160, entity model facility 162, event collection facility 164, event logging facility 166, analytics facility 168, dynamic policies facility 170, identity management facility 172, and marketplace management facility 174, as well as other facilities. For example, there may be a testing facility, a threat research facility, and other facilities. It should be understood that the threat management facility 100 may be implemented in whole or in part on a number of different compute instances, with some parts of the threat management facility on different compute instances in different locations. For example, some or all of one or more of the various facilities 100, 112-174 may be provided as part of a security agent S that is included in software running on a compute instance 10-26 within the enterprise facility. Some or all of one or more of the facilities 100, 112-174 may be provided on the same physical hardware or logical resource as a gateway, such as a firewall 10, or wireless access point 11. Some or all of one or more of the facilities may be provided on one or more cloud servers that are operated by the enterprise or by a security service provider, such as the cloud computing instance 109.

In embodiments, a marketplace provider 199 may make available one or more additional facilities to the enterprise facility 102 via the threat management facility 100. The marketplace provider may communicate with the threat management facility 100 via the marketplace interface facility 174 to provide additional functionality or capabilities to the threat management facility 100 and compute instances 10-26. As non-limiting examples, the marketplace provider 199 may be a third-party information provider, such as a physical security event provider; the marketplace provider 199 may be a system provider, such as a human resources system provider or a fraud detection system provider; the marketplace provider may be a specialized analytics provider; and so on. The marketplace provider 199, with appropriate permissions and authorization, may receive and send events, observations, inferences, controls, convictions, policy violations, or other information to the threat management facility. For example, the marketplace provider 199 may subscribe to and receive certain events, and in response, based on the received events and other events available to the marketplace provider 199, send inferences to the marketplace interface, and in turn to the analytics facility 168, which in turn may be used by the security management facility 122.

The identity provider 158 may be any remote identity management system or the like configured to communicate with an identity management facility 172, e.g., to confirm identity of a user as well as provide or receive other information about users that may be useful to protect against threats. In general, the identity provider may be any system or entity that creates, maintains, and manages identity information for principals while providing authentication services to relying party applications, e.g., within a federation or distributed network. The identity provider may, for example, offer user authentication as a service, where other applications, such as web applications, outsource the user authentication step to a trusted identity provider.

In embodiments, the identity provider 158 may provide user identity information, such as multi-factor authentication, to a SaaS application. Centralized identity providers such as Microsoft Azure, may be used by an enterprise facility instead of maintaining separate identity information for each application or group of applications, and as a centralized point for integrating multifactor authentication. In embodiments, the identity management facility 172 may communicate hygiene, or security risk information, to the identity provider 158. The identity management facility 172 may determine a risk score for a user based on the events, observations, and inferences about that user and the compute instances associated with the user. If a user is perceived as risky, the identity management facility 172 can inform the identity provider 158, and the identity provider 158 may take steps to address the potential risk, such as to confirm the identity of the user, confirm that the user has approved the SaaS application access, remediate the user's system, or such other steps as may be useful.

In embodiments, threat protection provided by the threat management facility 100 may extend beyond the network boundaries of the enterprise facility 102 to include clients (or client facilities) such as an endpoint 22 outside the enterprise facility 102, a mobile device 26, a cloud computing instance 109, or any other devices, services or the like that use network connectivity not directly associated with or controlled by the enterprise facility 102, such as a mobile network, a public cloud network, or a wireless network at a hotel or coffee shop. While threats may come from a variety of sources, such as from network threats, physical proximity threats, secondary location threats, the compute instances 10-26 may be protected from threats even when a compute instance 10-26 is not connected to the enterprise facility 102 network, such as when compute instances 22, 26 use a network that is outside of the enterprise facility 102 and separated from the enterprise facility 102, e.g., by a gateway, a public network, and so forth.

In some implementations, compute instances 10-26 may communicate with cloud applications, such as a SaaS application 156. The SaaS application 156 may be an application that is used by but not operated by the enterprise facility 102. Exemplary commercially available SaaS applications 156 include Salesforce, Amazon Web Services (AWS) applications, Google Apps applications, Microsoft Office 365 applications and so on. A given SaaS application 156 may communicate with an identity provider 158 to verify user identity consistent with the requirements of the enterprise facility 102. The compute instances 10-26 may communicate with an unprotected server (not shown) such as a web site or a third-party application through an internetwork 154 such as the Internet or any other public network, private network, or combination of these.

In embodiments, aspects of the threat management facility 100 may be provided as a stand-alone solution. In other embodiments, aspects of the threat management facility 100 may be integrated into a third-party product. An application programming interface (e.g. a source code interface) may be provided such that aspects of the threat management facility 100 may be integrated into or used by or with other applications. For instance, the threat management facility 100 may be stand-alone in that it provides direct threat protection to an enterprise or computer resource, where protection is subscribed to directly 100. Alternatively, the threat management facility may offer protection indirectly, through a third-party product, where an enterprise may subscribe to services through the third-party product, and threat protection to the enterprise may be provided by the threat management facility 100 through the third-party product.

The security management facility 122 may provide protection from a variety of threats by providing, as non-limiting examples, endpoint security and control, email security and control, web security and control, reputation-based filtering, machine learning classification, control of unauthorized users, control of guest and non-compliant computers, and more.

The security management facility 122 may provide malicious code protection to a compute instance. The security management facility 122 may include functionality to scan applications, files, and data for malicious code, remove or quarantine applications and files, prevent certain actions, perform remedial actions, as well as other security measures. Scanning may use any of a variety of techniques, including without limitation signatures, identities, classifiers, and other suitable scanning techniques. In embodiments, the scanning may include scanning some or all files on a periodic basis, scanning an application when the application is executed, scanning data transmitted to or from a device, scanning in response to predetermined actions or combinations of actions, and so forth. The scanning of applications, files, and data may be performed to detect known or unknown malicious code or unwanted applications. Aspects of the malicious code protection may be provided, for example, in the security agent of an endpoint 12, in a wireless access point 11 or firewall 10, as part of application protection 150 provided by the cloud, and so on.

In an embodiment, the security management facility 122 may provide for email security and control, for example to target spam, viruses, spyware, and phishing, to control email content, and the like. Email security and control may protect against inbound and outbound threats, protect email infrastructure, prevent data leakage, provide spam filtering, and more. Aspects of the email security and control may be provided, for example, in the security agent of an endpoint 12, in a wireless access point 11 or firewall 10, as part of application protection 150 provided by the cloud, and so on.

In an embodiment, security management facility 122 may provide for web security and control, for example, to detect or block viruses, spyware, malware, unwanted applications, help control web browsing, and the like, which may provide comprehensive web access control enabling safe, productive web browsing. Web security and control may provide Internet use policies, reporting on suspect compute instances, security and content filtering, active monitoring of network traffic, URI filtering, and the like. Aspects of the web security and control may be provided, for example, in the security agent of an endpoint 12, in a wireless access point 11 or firewall 10, as part of application protection 150 provided by the cloud, and so on.

In an embodiment, the security management facility 122 may provide for network access control, which generally controls access to and use of network connections. Network control may stop unauthorized, guest, or non-compliant systems from accessing networks, and may control network traffic that is not otherwise controlled at the client level. In addition, network access control may control access to virtual private networks (VPN), where VPNs may, for example, include communications networks tunneled through other networks and establishing logical connections acting as virtual networks. In embodiments, a VPN may be treated in the same manner as a physical network. Aspects of network access control may be provided, for example, in the security agent of an endpoint 12, in a wireless access point 11 or firewall 10, as part of application protection 150 provided by the cloud, e.g., from the threat management facility 100 or other network resource(s).

In an embodiment, the security management facility 122 may provide for host intrusion prevention through behavioral monitoring and/or runtime monitoring, which may guard against unknown threats by analyzing application behavior before or as an application runs. This may include monitoring code behavior, application programming interface calls made to libraries or to the operating system, or otherwise monitoring application activities. Monitored activities may include, for example, reading and writing to memory, reading and writing to disk, network communication, process interaction, and so on. Behavior and runtime monitoring may intervene if code is deemed to be acting in a manner that is suspicious or malicious. Aspects of behavior and runtime monitoring may be provided, for example, in the security agent of an endpoint 12, in a wireless access point 11 or firewall 10, as part of application protection 150 provided by the cloud, and so on.

In an embodiment, the security management facility 122 may provide for reputation filtering, which may target or identify sources of known malware. For instance, reputation filtering may include lists of URIs of known sources of malware or known suspicious IP addresses, code authors, code signers, or domains, that when detected may invoke an action by the threat management facility 100. Based on reputation, potential threat sources may be blocked, quarantined, restricted, monitored, or some combination of these, before an exchange of data can be made. Aspects of reputation filtering may be provided, for example, in the security agent of an endpoint 12, in a wireless access point 11 or firewall 10, as part of application protection 150 provided by the cloud, and so on. In embodiments, some reputation information may be stored on a compute instance 10-26, and other reputation data available through cloud lookups to an application protection lookup database, such as may be provided by application protection 150.

In embodiments, information may be sent from the enterprise facility 102 to a third party, such as a security vendor, or the like, which may lead to improved performance of the threat management facility 100. In general, feedback may be useful for any aspect of threat detection. For example, the types, times, and number of virus interactions that an enterprise facility 102 experiences may provide useful information for the preventions of future virus threats. Feedback may also be associated with behaviors of individuals within the enterprise, such as being associated with most common violations of policy, network access, unauthorized application loading, unauthorized external device use, and the like. In embodiments, feedback may enable the evaluation or profiling of client actions that are violations of policy that may provide a predictive model for the improvement of enterprise policies.

An update management facility 120 may provide control over when updates are performed. The updates may be automatically transmitted, manually transmitted, or some combination of these. Updates may include software, definitions, reputations or other code or data that may be useful to the various facilities. For example, the update facility 120 may manage receiving updates from a provider, distribution of updates to enterprise facility 102 networks and compute instances, or the like. In embodiments, updates may be provided to the enterprise facility's 102 network, where one or more compute instances on the enterprise facility's 102 network may distribute updates to other compute instances.

The threat management facility 100 may include a policy management facility 112 that manages rules or policies for the enterprise facility 102. Exemplary rules include access permissions associated with networks, applications, compute instances, users, content, data, and the like. The policy management facility 112 may use a database, a text file, other data store, or a combination to store policies. In an embodiment, a policy database may include a block list, a black list, an allowed list, a white list, and more. As a few non-limiting examples, policies may include a list of enterprise facility 102 external network locations/applications that may or may not be accessed by compute instances, a list of types/classifications of network locations or applications that may or may not be accessed by compute instances, and contextual rules to evaluate whether the lists apply. For example, there may be a rule that does not permit access to sporting websites. When a website is requested by the client facility, a security management facility 122 may access the rules within a policy facility to determine if the requested access is related to a sporting website.

The policy management facility 112 may include access rules and policies that are distributed to maintain control of access by the compute instances 10-26 to network resources. Exemplary policies may be defined for an enterprise facility, application type, subset of application capabilities, organization hierarchy, compute instance type, user type, network location, time of day, connection type, or any other suitable definition. Policies may be maintained through the threat management facility 100, in association with a third party, or the like. For example, a policy may restrict instant messaging (IM) activity by limiting such activity to support personnel when communicating with customers. More generally, this may allow communication for departments as necessary or helpful for department functions, but may otherwise preserve network bandwidth for other activities by restricting the use of IM to personnel that need access for a specific purpose. In an embodiment, the policy management facility 112 may be a stand-alone application, may be part of the network server facility 142, may be part of the enterprise facility 102 network, may be part of the client facility, or any suitable combination of these.

The policy management facility 112 may include dynamic policies that use contextual or other information to make security decisions. As described herein, the dynamic policies facility 170 may generate policies dynamically based on observations and inferences made by the analytics facility. The dynamic policies generated by the dynamic policy facility 170 may be provided by the policy management facility 112 to the security management facility 122 for enforcement.

In embodiments, the threat management facility 100 may provide configuration management as an aspect of the policy management facility 112, the security management facility 122, or some combination. Configuration management may define acceptable or required configurations for the compute instances 10-26, applications, operating systems, hardware, or other assets, and manage changes to these configurations. Assessment of a configuration may be made against standard configuration policies, detection of configuration changes, remediation of improper configurations, application of new configurations, and so on. An enterprise facility may have a set of standard configuration rules and policies for particular compute instances which may represent a desired state of the compute instance. For example, on a given compute instance 12, 14, 18, a version of a client firewall may be required to be running and installed. If the required version is installed but in a disabled state, the policy violation may prevent access to data or network resources. A remediation may be to enable the firewall. In another example, a configuration policy may disallow the use of USB disks, and policy management 112 may require a configuration that turns off USB drive access via a registry key of a compute instance. Aspects of configuration management may be provided, for example, in the security agent of an endpoint 12, in a wireless access point 11 or firewall 10, as part of application protection 150 provided by the cloud, or any combination of these.

In embodiments, the threat management facility 100 may also provide for the isolation or removal of certain applications that are not desired or may interfere with the operation of a compute instance 10-26 or the threat management facility 100, even if such application is not malware per se. The operation of such products may be considered a configuration violation. The removal of such products may be initiated automatically whenever such products are detected, or access to data and network resources may be restricted when they are installed and running. In the case where such applications are services which are provided indirectly through a third-party product, the applicable application or processes may be suspended until action is taken to remove or disable the third-party product.

The policy management facility 112 may also require update management (e.g., as provided by the update facility 120). Update management for the security facility 122 and policy management facility 112 may be provided directly by the threat management facility 100, or, for example, by a hosted system. In embodiments, the threat management facility 100 may also provide for patch management, where a patch may be an update to an operating system, an application, a system tool, or the like, where one of the reasons for the patch is to reduce vulnerability to threats.

In embodiments, the security facility 122 and policy management facility 112 may push information to the enterprise facility 102 network and/or the compute instances 10-26, the enterprise facility 102 network and/or compute instances 10-26 may pull information from the security facility 122 and policy management facility 112, or there may be a combination of pushing and pulling of information. For example, the enterprise facility 102 network and/or compute instances 10-26 may pull update information from the security facility 122 and policy management facility 112 via the update facility 120, an update request may be based on a time period, by a certain time, by a date, on demand, or the like. In another example, the security facility 122 and policy management facility 112 may push the information to the enterprise facility's 102 network and/or compute instances 10-26 by providing notification that there are updates available for download and/or transmitting the information. In an embodiment, the policy management facility 112 and the security facility 122 may work in concert with the update management facility 120 to provide information to the enterprise facility's 102 network and/or compute instances 10-26. In various embodiments, policy updates, security updates and other updates may be provided by the same or different modules, which may be the same or separate from a security agent running on one of the compute instances 10-26.

As threats are identified and characterized, the definition facility 114 of the threat management facility 100 may manage definitions used to detect and remediate threats. For example, identity definitions may be used for scanning files, applications, data streams, etc. for the determination of malicious code. Identity definitions may include instructions and data that can be parsed and acted upon for recognizing features of known or potentially malicious code. Definitions also may include, for example, code or data to be used in a classifier, such as a neural network or other classifier that may be trained using machine learning. Updated code or data may be used by the classifier to classify threats. In embodiments, the threat management facility 100 and the compute instances 10-26 may be provided with new definitions periodically to include most recent threats. Updating of definitions may be managed by the update facility 120, and may be performed upon request from one of the compute instances 10-26, upon a push, or some combination. Updates may be performed upon a time period, on demand from a device 10-26, upon determination of an important new definition or a number of definitions, and so on.

A threat research facility (not shown) may provide a continuously ongoing effort to maintain the threat protection capabilities of the threat management facility 100 in light of continuous generation of new or evolved forms of malware. Threat research may be provided by researchers and analysts working on known threats, in the form of policies, definitions, remedial actions, and so on.

The security management facility 122 may scan an outgoing file and verify that the outgoing file is permitted to be transmitted according to policies. By checking outgoing files, the security management facility 122 may be able discover threats that were not detected on one of the compute instances 10-26, or policy violation, such transmittal of information that should not be communicated unencrypted.

The threat management facility 100 may control access to the enterprise facility 102 networks. A network access facility 124 may restrict access to certain applications, networks, files, printers, servers, databases, and so on. In addition, the network access facility 124 may restrict user access under certain conditions, such as the user's location, usage history, need to know, job position, connection type, time of day, method of authentication, client-system configuration, or the like. Network access policies may be provided by the policy management facility 112, and may be developed by the enterprise facility 102, or pre-packaged by a supplier. Network access facility 124 may determine if a given compute instance 10-22 should be granted access to a requested network location, e.g., inside or outside of the enterprise facility 102. Network access facility 124 may determine if a compute instance 22, 26 such as a device outside the enterprise facility 102 may access the enterprise facility 102. For example, in some cases, the policies may require that when certain policy violations are detected, certain network access is denied. The network access facility 124 may communicate remedial actions that are necessary or helpful to bring a device back into compliance with policy as described below with respect to the remedial action facility 128. Aspects of the network access facility 124 may be provided, for example, in the security agent of the endpoint 12, in a wireless access point 11, in a firewall 10, as part of application protection 150 provided by the cloud, and so on.

In an embodiment, the network access facility 124 may have access to policies that include one or more of a block list, a black list, an allowed list, a white list, an unacceptable network site database, an acceptable network site database, a network site reputation database, or the like of network access locations that may or may not be accessed by the client facility. Additionally, the network access facility 124 may use rule evaluation to parse network access requests and apply policies. The network access rule facility 124 may have a generic set of policies for all compute instances, such as denying access to certain types of websites, controlling instant messenger accesses, or the like. Rule evaluation may include regular expression rule evaluation, or other rule evaluation method(s) for interpreting the network access request and comparing the interpretation to established rules for network access. Classifiers may be used, such as neural network classifiers or other classifiers that may be trained by machine learning.

The threat management facility 100 may include an asset classification facility 160. The asset classification facility will discover the assets present in the enterprise facility 102. A compute instance such as any of the compute instances 10-26 described herein may be characterized as a stack of assets. The one level asset is an item of physical hardware. The compute instance may be, or may be implemented on physical hardware, and may have or may not have a hypervisor, or may be an asset managed by a hypervisor. The compute instance may have an operating system (e.g., Windows, MacOS, Linux, Android, iOS). The compute instance may have one or more layers of containers. The compute instance may have one or more applications, which may be native applications, e.g., for a physical asset or virtual machine, or running in containers within a computing environment on a physical asset or virtual machine, and those applications may link libraries or other code or the like, e.g., for a user interface, cryptography, communications, device drivers, mathematical or analytical functions and so forth. The stack may also interact with data. The stack may also or instead interact with users, and so users may be considered assets.

The threat management facility may include entity models 162. The entity models may be used, for example, to determine the events that are generated by assets. For example, some operating systems may provide useful information for detecting or identifying events. For example, operating systems may provide process and usage information that may be accessed through an API. As another example, it may be possible to instrument certain containers to monitor the activity of applications running on them. As another example, entity models for users may define roles, groups, permitted activities and other attributes.

The event collection facility 164 may be used to collect events from any of a wide variety of sensors that may provide relevant events from an asset, such as sensors on any of the compute instances 10-26, the application protection facility 150, a cloud computing instance 109 and so on. The events that may be collected may be determined by the entity models. There may be a variety of events collected. Events may include, for example, events generated by the enterprise facility 102 or the compute instances 10-26, such as by monitoring streaming data through a gateway such as firewall 10 and wireless access point 11, monitoring activity of compute instances, monitoring stored files/data on the compute instances 10-26 such as desktop computers, laptop computers, other mobile computing devices, and cloud computing instances 19, 109. Events may range in granularity. An exemplary event may be communication of a specific packet over the network. Another exemplary event may be identification of an application that is communicating over a network.

The event logging facility 166 may be used to store events collected by the event collection facility 164. The event logging facility 166 may store collected events so that they can be accessed and analyzed by the analytics facility 168. Some events may be collected locally, and some events may be communicated to an event store in a central location or cloud facility. Events may be logged in any suitable format.

Events collected by the event logging facility 166 may be used by the analytics facility 168 to make inferences and observations about the events. These observations and inferences may be used as part of policies enforced by the security management facility Observations or inferences about events may also be logged by the event logging facility 166.

When a threat or other policy violation is detected by the security management facility 122, the remedial action facility 128 may be used to remediate the threat. Remedial action may take a variety of forms, non-limiting examples including collecting additional data about the threat, terminating or modifying an ongoing process or interaction, sending a warning to a user or administrator, downloading a data file with commands, definitions, instructions, or the like to remediate the threat, requesting additional information from the requesting device, such as the application that initiated the activity of interest, executing a program or application to remediate against a threat or violation, increasing telemetry or recording interactions for subsequent evaluation, (continuing to) block requests to a particular network location or locations, scanning a requesting application or device, quarantine of a requesting application or the device, isolation of the requesting application or the device, deployment of a sandbox, blocking access to resources, e.g., a USB port, or other remedial actions. More generally, the remedial action facility 122 may take any steps or deploy any measures suitable for addressing a detection of a threat, potential threat, policy violation or other event, code or activity that might compromise security of a computing instance 10-26 or the enterprise facility 102.

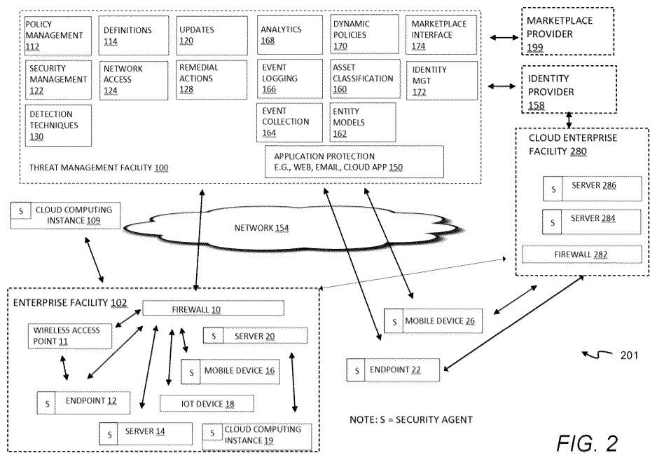

FIG. 2 depicts a block diagram of a threat management system, according to some embodiments described herein. FIG. 2 depicts a block diagram of a threat management system 201 such as any of the threat management systems described herein, and including a cloud enterprise facility 280. The cloud enterprise facility 280 may include servers 284, 286, and a firewall 282. The servers 284, 286 on the cloud enterprise facility 280 may run one or more enterprise applications and make them available to the enterprise facilities 102 compute instances 10-26. It should be understood that there may be any number of servers 284, 286 and firewalls 282, as well as other compute instances in a given cloud enterprise facility 280. It also should be understood that a given enterprise facility may use both SaaS applications 156 and cloud enterprise facilities 280, or, for example, a SaaS application 156 may be deployed on a cloud enterprise facility 280. As such, the configurations in FIG. 1 and FIG. 2 are shown by way of examples and not exclusive alternatives.

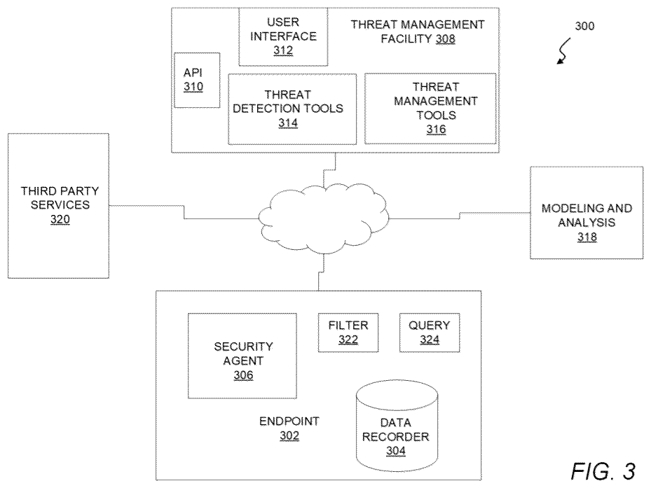

FIG. 3 shows a system 300 for enterprise network threat detection. The system 300 may use any of the various tools and techniques for threat management contemplated herein. In the system, a number of endpoints such as the endpoint 302 may log events in a data recorder 304. A local agent on the endpoint 302 such as the security agent 306 may filter this data and feed a filtered data stream to a threat management facility 308 such as a central threat management facility or any of the other threat management facilities described herein. The threat management facility 308 can locally or globally tune filtering by local agents based on the current data stream, and can query local event data recorders for additional information where necessary or helpful in threat detection or forensic analysis. The threat management facility 308 may also or instead store and deploy a number of security tools such as a web-based user interface that is supported by machine learning models to aid in the identification and assessment of potential threats by a human user. This may, for example, include machine learning analysis of new code samples, models to provide human-readable context for evaluating potential threats, and any of the other tools or techniques described herein. More generally, the threat management facility 308 may provide any of a variety of threat management tools 316 to aid in the detection, evaluation, and remediation of threats or potential threats.

The threat management facility 308 may perform a range of threat management functions such as any of those described herein. The threat management facility 308 may generally include an application programming interface 310 to third party services 320, a user interface 312 for access to threat management and network administration functions, and a number of threat detection tools 314.

In general, the application programming interface 310 may support programmatic connections with third party services 320. The application programming interface 310 may, for example, connect to Active Directory or other customer information about files, data storage, identities and user profiles, roles, access privileges and so forth. More generally the application programming interface 310 may provide a programmatic interface for customer or other third party context, information, administration and security tools, and so forth. The application programming interface 310 may also or instead provide a programmatic interface for hosted applications, identity provider integration tools or services, and so forth.

The user interface 312 may include a website or other graphical interface or the like, and may generally provide an interface for user interaction with the threat management facility 308, e.g., for threat detection, network administration, audit, configuration and so forth. This user interface 312 may generally facilitate human curation of intermediate threats as contemplated herein, e.g., by presenting intermediate threats along with other supplemental information, and providing controls for user to dispose of such intermediate threats as desired, e.g., by permitting execution or access, by denying execution or access, or by engaging in remedial measures such as sandboxing, quarantining, vaccinating, and so forth.

The threat detection tools 314 may be any of the threat detection tools, algorithms, techniques or the like described herein, or any other tools or the like useful for detecting threats or potential threats within an enterprise network. This may, for example, include signature based tools, behavioral tools, machine learning models, and so forth. In general, the threat detection tools 314 may use event data provided by endpoints within the enterprise network, as well as any other available context such as network activity, heartbeats, and so forth to detect malicious software or potentially unsafe conditions for a network or endpoints connected to the network. In one aspect, the threat detection tools 314 may usefully integrate event data from a number of endpoints (including, e.g., network components such as gateways, routers, and firewalls) for improved threat detection in the context of complex or distributed threats. The threat detection tools 314 may also or instead include tools for reporting to a separate modeling and analysis platform 318, e.g., to support further investigation of security issues, creation or refinement of threat detection models or algorithms, review and analysis of security breaches, and so forth.

The threat management tools 316 may generally be used to manage or remediate threats to the enterprise network that have been identified with the threat detection tools 314 or otherwise. Threat management tools 316 may, for example, include tools for sandboxing, quarantining, removing, or otherwise remediating or managing malicious code or malicious activity, e.g., using any of the techniques described herein.

The endpoint 302 may be any of the endpoints or other compute instances or the like described herein. This may, for example, include end-user computing devices, mobile devices, firewalls, gateways, servers, routers and any other computing devices or instances that might connect to an enterprise network. As described above, the endpoint 302 may generally include a security agent 306 that locally supports threat management on the endpoint 302, such as by monitoring for malicious activity, managing security components on the endpoint 302, maintaining policy compliance, and communicating with the threat management facility 308 to support integrated security protection as contemplated herein. The security agent 306 may, for example, coordinate instrumentation of the endpoint 302 to detect various event types involving various computing objects on the endpoint 302, and supervise logging of events in a data recorder 304. The security agent 306 may also or instead scan computing objects such as electronic communications or files, monitor behavior of computing objects such as executables, and so forth. The security agent 306 may, for example, apply signature-based or behavioral threat detection techniques, machine learning models (e.g. models developed by the modeling and analysis platform), or any other tools or the like suitable for detecting malware or potential malware on the endpoint 302.

The data recorder 304 may log events occurring on or related to the endpoint. This may, for example, include events associated with computing objects on the endpoint 302 such as file manipulations, software installations, and so forth. This may also or instead include activities directed from the endpoint 302, such as requests for content from Uniform Resource Locators or other network activity involving remote resources. The data recorder 304 may record data at any frequency and any level of granularity consistent with proper operation of the endpoint 302 in an intended or desired manner.

The endpoint 302 may include a filter 322 to manage a flow of information from the data recorder 304 to a remote resource such as the threat detection tools 314 of the threat management facility 308. In this manner, a detailed log of events may be maintained locally on each endpoint, while network resources can be conserved for reporting of a filtered event stream that contains information believed to be most relevant to threat detection. The filter 322 may also or instead be configured to report causal information that causally relates collections of events to one another. In general, the filter 322 may be configurable so that, for example, the threat management facility 308 can increase or decrease the level of reporting based on a current security status of the endpoint, a group of endpoints, the enterprise network, and the like. The level of reporting may also or instead be based on currently available network and computing resources, or any other appropriate context.

In another aspect, the endpoint 302 may include a query interface 324 so that remote resources such as the threat management facility 308 can query the data recorder 304 remotely for additional information. This may include a request for specific events, activity for specific computing objects, or events over a specific time frame, or some combination of these. Thus for example, the threat management facility 308 may request all changes to the registry of system information for the past forty eight hours, all files opened by system processes in the past day, all network connections or network communications within the past hour, or any other parametrized request for activities monitored by the data recorder 304. In another aspect, the entire data log, or the entire log over some predetermined window of time, may be requested for further analysis at a remote resource.

It will be appreciated that communications among third party services 320, a threat management facility 308, and one or more endpoints such as the endpoint 302 may be facilitated by using consistent naming conventions across products and machines. For example, the system 300 may usefully implement globally unique device identifiers, user identifiers, application identifiers, data identifiers, Uniform Resource Locators, network flows, and files. The system may also or instead use tuples to uniquely identify communications or network connections based on, e.g., source and destination addresses and so forth.

According to the foregoing, a system disclosed herein includes an enterprise network, and endpoint coupled to the enterprise network, and a threat management facility coupled in a communicating relationship with the endpoint and a plurality of other endpoints through the enterprise network. The endpoint may have a data recorder that stores an event stream of event data for computing objects, a filter for creating a filtered event stream with a subset of event data from the event stream, and a query interface for receiving queries to the data recorder from a remote resource, the endpoint further including a local security agent configured to detect malware on the endpoint based on event data stored by the data recorder, and further configured to communicate the filtered event stream over the enterprise network. The threat management facility may be configured to receive the filtered event stream from the endpoint, detect malware on the endpoint based on the filtered event stream, and remediate the endpoint when malware is detected, the threat management facility further configured to modify security functions within the enterprise network based on a security state of the endpoint.

The threat management facility may be configured to adjust reporting of event data through the filter in response to a change in the filtered event stream received from the endpoint. The threat management facility may be configured to adjust reporting of event data through the filter when the filtered event stream indicates a compromised security state of the endpoint. The threat management facility may be configured to adjust reporting of event data from one or more other endpoints in response to a change in the filtered event stream received from the endpoint. The threat management facility may be configured to adjust reporting of event data through the filter when the filtered event stream indicates a compromised security state of the endpoint. The threat management facility may be configured to request additional data from the data recorder when the filtered event stream indicates a compromised security state of the endpoint. The threat management facility may be configured to request additional data from the data recorder when a security agent of the endpoint reports a security compromise independently from the filtered event stream. The threat management facility may be configured to adjust handling of network traffic at a gateway to the enterprise network in response to a predetermined change in the filtered event stream. The threat management facility may include a machine learning model for identifying potentially malicious activity on the endpoint based on the filtered event stream. The threat management facility may be configured to detect potentially malicious activity based on a plurality of filtered event streams from a plurality of endpoints. The threat management facility may be configured to detect malware on the endpoint based on the filtered event stream and additional context for the endpoint.

The data recorder may record one or more events from a kernel driver. The data recorder may record at least one change to a registry of system settings for the endpoint. The endpoints may include a server, a firewall for the enterprise network, a gateway for the enterprise network, or any combination of these. The endpoint may be coupled to the enterprise network through a virtual private network or a wireless network. The endpoint may be configured to periodically transmit a snapshot of aggregated, unfiltered data from the data recorder to the threat management facility for remote storage. The data recorder may be configured to delete records in the data recorder corresponding to the snapshot in order to free memory on the endpoint for additional recording.

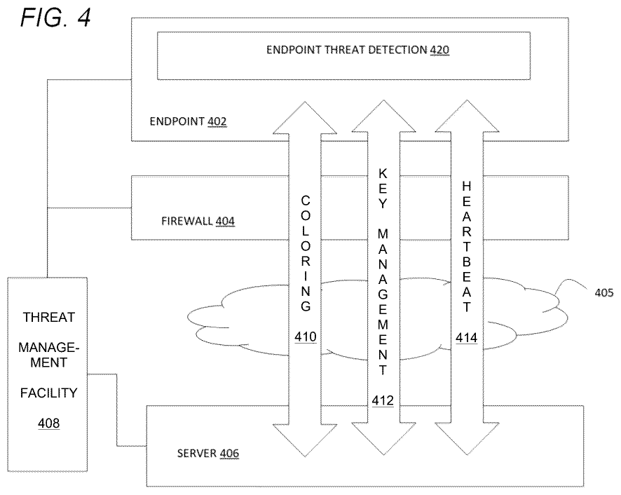

FIG. 4 illustrates a threat management system. In general, the system may include an endpoint 402, a firewall (gateway) 404, a server 406 and a threat management facility 408 coupled to one another directly or indirectly through a data network 405, all as generally described above. Each of the entities depicted in FIG. 4 may, for example, be implemented on one or more computing devices such as the computing device described herein. A number of systems may be distributed across these various components to support threat detection, such as a coloring system 410, a key management system 412 and a heartbeat system 414, each of which may include software components executing on any of the foregoing system components, and each of which may communicate with the threat management facility 408 and an endpoint threat detection agent 420 executing on the endpoint 402 to support improved threat detection and remediation.

The coloring system 410 may be used to label or color software objects for improved tracking and detection of potentially harmful activity. The coloring system 410 may, for example, label files, executables, processes, network communications, data sources and so forth with any suitable information. A variety of techniques may be used to select static and/or dynamic labels for any of these various software objects, and to manage the mechanics of applying and propagating coloring information as appropriate. For example, a process may inherit a color from an application that launches the process. Similarly, a file may inherit a color from a process when it is created or opened by a process, and/or a process may inherit a color from a file that the process has opened. More generally, any type of labeling, as well as rules for propagating, inheriting, changing, or otherwise manipulating such labels, may be used by the coloring system 410 as contemplated herein.

The key management system 412 may support management of keys for the endpoint 402 in order to selectively permit or prevent access to content on the endpoint 402 on a file-specific basis, a process-specific basis, an application-specific basis, a user-specific basis, or any other suitable basis in order to prevent data leakage, and in order to support more fine-grained and immediate control over access to content on the endpoint 402 when a security compromise is detected. Thus, for example, if a particular process executing on the endpoint is compromised, or potentially compromised or otherwise under suspicion, keys to that process may be revoked in order to prevent, e.g., data leakage or other malicious activity.

The heartbeat system 414 may be used to provide periodic or aperiodic information from the endpoint 402 or other system components about system health, security, status, and so forth. A heartbeat may be encrypted or plaintext, or some combination of these, and may be communicated unidirectionally (e.g., from the endpoint 408 to the threat management facility 408) or bidirectionally (e.g., between the endpoint 402 and the server 406, or any other pair of system components) on any useful schedule.

In general, these various monitoring and management systems may cooperate to provide improved threat detection and response. For example, the coloring system 410 may be used to evaluate when a particular process is potentially opening inappropriate files based on an inconsistency or mismatch in colors, and a potential threat may be confirmed based on an interrupted heartbeat from the heartbeat system 414. The key management system 412 may then be deployed to revoke keys to the process so that no further files can be opened, deleted, or otherwise modified. More generally, the cooperation of these systems enables a wide variety of reactive measures that can improve detection and remediation of potential threats to an endpoint.

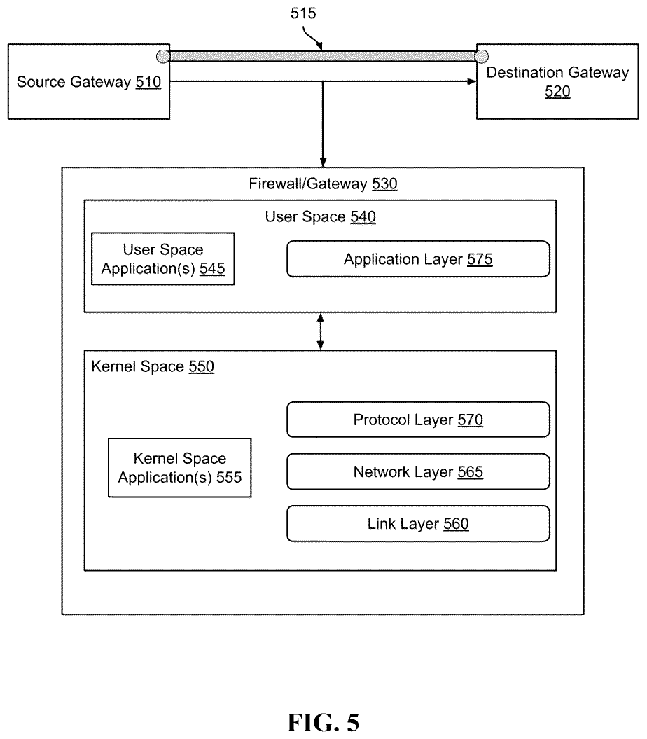

FIG. 5 depicts a block diagram of a firewall that is utilized to manage traffic between a source gateway and a destination gateway, according to some embodiments described herein.

As depicted in FIG. 5, a VPN tunnel 515 connects a source gateway 510 and a destination gateway 520. In some implementations, the gateways act as central points for secure connections, enabling devices behind them (not shown) to communicate with other networks. For example, a user device (client device), e.g., endpoint 402 described with reference to FIG. 4, may be behind source gateway 510 and a server device may be behind destination gateway 520. In some cases, an endpoint device may be a source gateway 510 that initiates a tunnel to the firewall. In some cases, the destination gateway 520 may be a server endpoint device or a gateway.

In some implementations, the endpoint device may be similar to endpoint 22 or mobile device 26 that is attempting to connect to cloud enterprise facility 280 via firewall 282 described with reference to FIG. 2. In some other implementations, a source gateway 510 and a destination gateway 520 may be respective gateways that enable a VPN tunnel to be established between enterprise facility 102 and cloud enterprise facility 280 described with reference to FIG. 2.

In some implementations, the VPN tunnel may be configured as a site-to-site VPN where the VPN tunnel is provided between gateways (firewalls), and respective endpoints are behind the gateways (firewalls). In some other implementations, the VPN tunnel may be configured as a remote access VPN, and the VPN tunnel is provided between an endpoint device and a gateway (firewall) in order to enable the endpoint device to access resources behind the firewall.

A firewall/gateway 530, similar to firewall 10 described with reference to FIGS. 1-2 and firewall 404 described with reference to FIG. 4, regulates traffic between source gateway 510 and destination gateway 520. The firewall may include a user space partition 540 (user space 540) and a kernel space partition 550 (kernel space 550). The user space 540 may include a plurality of user space application(s) 545 and may include an implementation of an application layer 575 os a network protocol. User space application(s) 545 can access data stored in the user space 540 but cannot directly access data stored in the kernel space 550. Such data can only be accessed by the user space applications 545 via calls to an operating system (OS) of firewall 530.

Kernel space 550 may include kernel space application(s) 555 and includes an implementation of a network protocol that includes a link layer 560, a network layer 565, and a protocol layer (transport layer) 570.

User space application(s) 550 executes in user space 540 such that user space application(s) 550 have access to memory addresses allocated to user space 540, but not to any memory addresses in kernel space 550. The user space application(s) 550 can include programs and libraries that the operating system uses to interact with the kernel. When a request for a VPN connection is received (e.g., by a VPN gateway), the user space application 550 authenticates the request. In some embodiments, authentication includes a handshake process where messages are exchanged between a client device and a server device to establish mutual trust.

The kernel space 550 may refer to a memory partition that stores data that is only accessible to processes with operating system privileges. The traffic management application advantageously uses the kernel space 550 to perform VPN processes with lower processing overhead. For example, the kernel processes may include exception handling, such as when an alert message is received and/or an error is detected.

The VPN tunnel 515 may be utilized to connect remote users to a corporate network (enterprise network) as well as to provide interconnections between corporate networks. In some implementations, the VPN tunnel 515 may be a route-based VPN (RBVPN) that may be set up to connect a head office (HO) with a branch office (BO), with traffic allowed both ways.

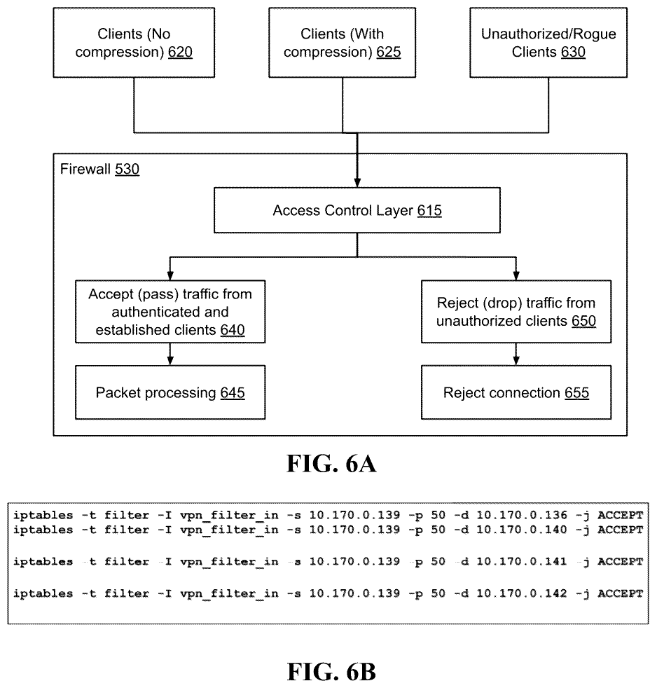

FIG. 6A is a block diagram that depicts example objectives of traffic management of VPN traffic by a firewall, according to some embodiments described herein.

FIG. 6A depicts a firewall 530 that includes access control layer 615. The firewall 530 may receive data traffic from client devices 620 that do not use compression, from client devices 625 that use compression, and from unauthorized/rogue client devices 630. Client devices 620 and client devices 625 may be similar to endpoint 22 described with reference to FIGS. 1-2, to endpoint 302 described with reference to FIG. 3, and to endpoint 402 described with reference to FIG. 4. Based on the source of the data traffic, access control layer 615 may accept (pass) data traffic from authenticated and established clients 640 and reject (drop) traffic from unauthorized clients 650.

Accepted traffic 640 is transmitted for further packet processing 645, while rejected traffic 650 may have the connection rejected 655. In some implementations, details regarding the rejected connection 655 may be provided to threat management facility 308 and/or modeling and analysis platform 318 described with reference to FIG. 3.

As described earlier, a firewall serves as a gatekeeper for a network, preventing unauthorized access to network resources through the VPN tunnel. The firewall enables a network administrator to define specific rules for data traffic that may be allowed on the network, enhancing security and performance. Data traffic that is not to be permitted is blocked as close to the originating client as possible, thereby reducing unnecessary traffic over the VPN tunnel and improving network performance.

FIG. 6B depicts example commands utilized for traffic management of VPN traffic by a firewall, according to some embodiments described herein.

Filtering of data packets at a firewall is performed based on rules defined by network administrator(s) and which are utilized to configure the firewall. In some implementations, the configuration of the firewall may be based on commands issued, e.g., via a user space application such as user space application 545 described with reference to FIG. 5.

In some implementations, an iptables command or a nftables command may be issued (executed) to perform the configuration of the firewall. FIG. 6B depicts illustrative examples of iptables commands that may be utilized to perform the firewall configuration. An iptables command may include a packet matching table (example tables are filter, nat, mangle, raw, etc.) which the command should operate on, options that specify a type of action to be performed (example actions are ACCEPT, REJECT, etc.), and parameters that are utilized along with the rule specification.

In this illustrative example, the iptables command utilized to configure a VPN tunnel is of the format:
iptables-t filter-I vpn_filter_in-s 10.170.0.139-p 50-d 10.170.0.136 -j ACCEPT

This example iptables command is utilized to specify a rule associated with a filter table to insert (“I”) into a list a source gateway IP address (“10.170.0.139”) and a destination gateway IP address (“10.170.0.136”), wherein the rule specifies that the protocol (“p”) of the packet is associated with the numeric identifier 50, and that if a packet meets the above specification, the action (“j”) to be performed is to accept (“ACCEPT”) the packet for onward transmission and/or packet processing.

As depicted in FIG. 6B, the iptables command can be sequentially issued to add a plurality of source gateway IP addresses and destination gateway IP addresses to a list of valid VPN tunnels, data traffic from which is to be accepted for packet processing.

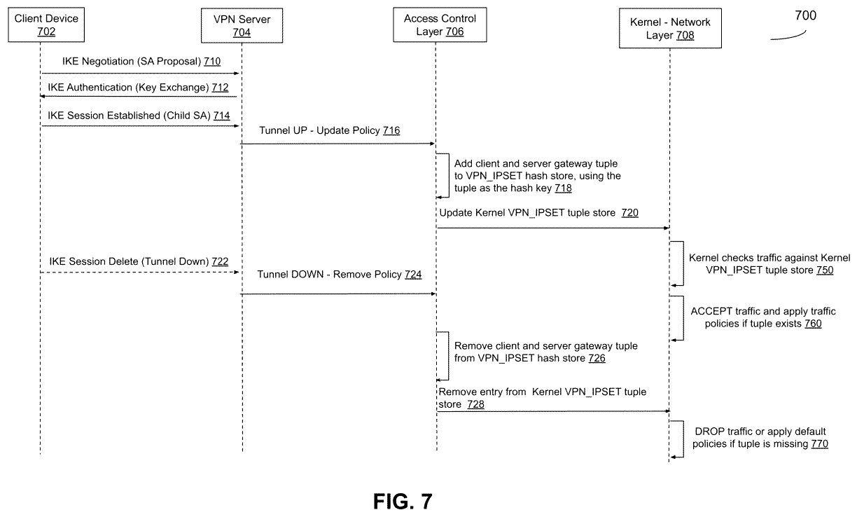

FIG. 7 is a sequence diagram that depicts traffic management of VPN traffic by a firewall, according to some embodiments described herein.

A network environment 700 includes a client device 702, a VPN server 704, an access control layer 706, and a kernel (Network layer) 708.

Establishment of a VPN tunnel between the client device 702 and VPN server 704 commences with authentication of the client device 702. To this end, an IKE negotiation (Security Association (SA) Proposal) is transmitted 710 from the client device 702 to the VPN server 704. The VPN server 704 responds 712 with a successful IKE Authentication message, and an IKE session corresponding to the particular VPN tunnel is established 714 with the transmission of a child SA.

The VPN server 704 transmits 716 a “Tunnel UP” message to the access control layer 706 in order to update a network policy. In some implementations, the message may further include a source (client) gateway IP address and the destination (server) gateway IP address (associated with the VPN tunnel. In response to the “Tunnel UP” message, the access control layer adds 718 the client gateway tuple to a VPN_IPSET hash store, using the client gateway tuple as a hash key.

The access control layer 706 updates 720 a VPN_IPSET tuple store of the kernel (network layer) 708.

When a session is to be terminated, an IKE Session Delete message may be transmitted 722 by client device 702 to the VPN server 704. In response, the VPN server 704 transmits 724 a “Tunnel DOWN” message to the access control layer 706 in order to remove the policy corresponding to the VPN tunnel that is to be deleted. Accordingly, the corresponding client and server gateway tuple is removed 726 from the VPN_IPSET hash store at the access control layer 706.

A message may be transmitted 728 from the access control layer 706 to the kernel (network layer) 708 to remove a corresponding entry at the kernel VPN_IPSET tuple store.

The VPN_IPSET tuple store is utilized by the kernel to perform packet filtering of incoming packets. In this illustrative example, the kernel checks 750 data traffic against the kernel VPN_IPSET store, and accepts 760 the traffic and applies suitable traffic policies if the tuple corresponding to the data traffic exists in the VPN_IPSET store, and drops 770 or applies default policies of the tuple is missing in the VPN_IPSET store.

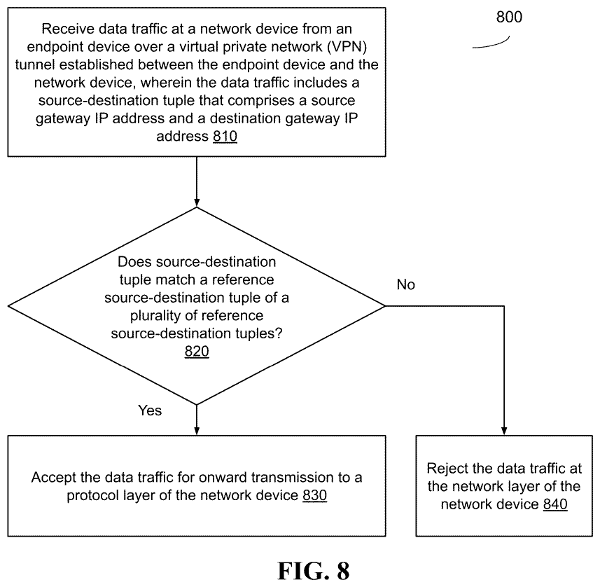

FIG. 8 illustrates an example method for management of traffic in a virtual private network (VPN), according to some embodiments described herein.

Method 800 may commence at block 810. At block 810, data traffic may be received at a network device from an endpoint device over a virtual private network (VPN) tunnel established between the endpoint device and the network device. In some implementations, the network device may be a VPN server or a firewall associated with a private network. In some implementations, the VPN tunnel may be established by performing an internet key exchange (IKE) negotiation between the endpoint device and the network device.

In some implementations, the data traffic includes a source-destination tuple that comprises a source gateway IP address and a destination gateway IP address. Block 810 may be followed by block 820.

At block 820, it may be determined, at a network layer of the network device, whether the source-destination tuple matches a reference source-destination tuple of a plurality of reference source-destination tuples. In some implementations, a reference source-destination tuple may include a respective reference source gateway IP address and a respective reference destination gateway IP address.

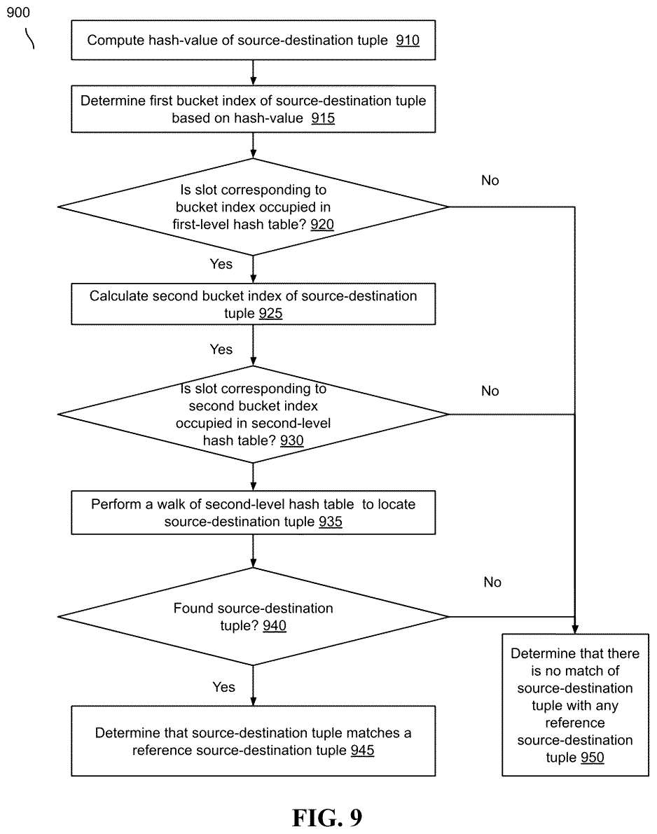

In some implementations, determining whether the source-destination tuple matches the reference source-destination tuple may include computing a hash value based on the source-destination tuple, wherein the hash value is unique to the source-destination tuple, and performing a search of the plurality of reference source-destination tuples based on the hash value. For example, a respective hash value may be calculated for each of the plurality of reference tuples and performing the search may include determining if the hash value of a particular reference tuple matches the hash value of the source destination tuple. An example method to match for matching a source-destination tuple with a reference source-destination tuple is described with reference to FIG. 9.

If it is determined at block 820 that the source-destination tuple matches the reference source-destination tuple, block 820 may be followed by block 830, else block 820 may be followed by block 840.

At block 830, the data traffic may be accepted at the network device for onward transmission to a protocol layer of the network device. In some implementations, based on the determination that the source-destination tuple matches the reference source-destination tuple, the data traffic may be forwarded to the protocol layer of the network device. In some implementations, the forwarding may be performed without subjecting the VPN traffic to network address translation, which may improve overall network performance.

At block 840, based on a determination that the source-destination tuple does not match any reference source-destination tuple, the data traffic may be rejected (dropped) at the network layer of the network device.

In some implementations, prior to receiving the data traffic from the endpoint device, a tuple store may be generated at the network device that includes the plurality of reference source-destination tuples based on a source gateway IP address and a destination gateway IP address associated with one or more virtual private network (VPN) tunnels that have been established at a protocol layer of the network device.

The tuple store may be generated based on utilization of IP sets, which is a framework provided within the kernel and administered by the ipset utility. Depending on the type, an IP set may store identifiers such as IP addresses, networks, (TCP/UDP) port numbers, MAC addresses, interface names or combinations thereof. The tuple store enables faster matching when a received identifier is to be compared with elements stored in an IPset.

In some implementations, the IP sets may be of the format [hash: net, net], where each element (tuple) of an IP set includes a respective source IP address and destination IP address associated with a VPN tunnel. In some implementations, the IP set may be generated by issuing an iptables command based on an ipset list that includes a respective source IP address and destination IP address associated with one or more established VPN tunnels associated with a firewall.

In some implementations, the VPN tunnel may provide support for both compressed data traffic and uncompressed data traffic. Since the compressed data traffic and uncompressed data traffic are configured based on different protocols, method 900 may be utilized to support compressed data traffic and uncompressed data traffic.

Individual sets of source-destination tuples are generated corresponding to VPN tunnels that convey compressed data and VPN tunnels that convey uncompressed data. For example, a first set (“vpn_gw_set”) may include source-destination tuples associated with VPN gateways that do not have compression enabled and a second set (“compress_vpn_gw_set”) may include source-destination tuples associated with VPN gateways that do have compression enabled.

The first set may be created by the command:
IPSET-N vpn_gw_set “hash: net, net” family inet

Insertion and deletion of tuples to and from the first set may be performed via commands:
ipset add vpn_gw_set<remote-gw-lP, local-gw-lP> and
ipset del vpn_gw_set<remote-gw-lP, local-gw-lP>

The second set may be created by the command:
IPSET-N compress_vpn_gw_set “hash: net, net” family inet maxelem $vpn_gw_ipset_size

Insertion and deletion of tuples to and from the second set may be performed via commands:
ipset add compress_vpn_gw_set<remote-gw-lP, local-gw-lP> and
ipset del compress_vpn_gw_set<remote-gw-lP, local-gw-lP>

In some implementations, a single combined set may be created from the first set and the second set. This IP set of type [list: set] acts as a container for the two sets: vpn_gw_set and compress_vpn_gw_set, and may be utilized to match VPN traffic based on a single reference in iptables rules, regardless of compression settings.

In some implementations, the iptables rules may be established for two tables; filter tables and nat tables.

In some implementations, the filter tables may be utilized to control the forwarding of packets based on VPN gateway IP pairs.

For example, the command chain
iptables-t filter-I vpn_filter_in_data-m set--match-set
   combined_vpn_gw_set src, dst-p esp-j ACCEPT
iptables-t filter-I vpn_filter_in_data-m set--match-set
   compress_vpn_gw_set src, dst-p 4-j ACCEPT
      may be utilized to control packet forwarding for data packets configured based on the ESP protocol and IP-ENCAP protocols.

In some implementations, the nat tables may be utilized for network address translation (NAT) of VPN traffic. For example, the following command chain may be utilized to ensure that VPN traffic between specified gateways is not subjected to further NAT.
iptables-t nat-I vpn_nat_post-m set--match-set combined_vpn_gw_set
   dst, src-p esp-j ACCEPT
iptables-t nat-I vpn_nat_post-m set--match-set compress_vpn_gw_set
   dst, src-p 4-j ACCEPT

FIG. 9 illustrates an example method to match a source-destination tuple with a reference source-destination tuple, according to some embodiments described herein.

In some implementations, method 900 may be utilized to perform a hash-based match of a source-destination tuple with a reference source-destination tuple. In some implementations, the hash-based match may be based on a first-level hash table and a second-level hash table and/or utilize a double-array approach. In some implementations, the hash value of a source-destination tuple may be computed based on a Jenkins hash function. In some implementations, the first-level hash table may be associated with a first initial seed value and the second-level hash table may be associated with a second initial seed value. In some implementations, method 900 may include determining whether the source-destination tuple matches a reference source-destination tuple by executing a kernel level process that performs a comparison of a hash of the source-destination tuple with respective hashes of the plurality of reference source-destination tuples. Method 900 may begin at block 910.

At block 910, a hash-value of the source-destination tuple is computed. In some implementations, the hash-value may be computed based on a Jenkins hash (jhash2) function applied to the keypair (src, dst) that is based on the source-destination tuple. Block 910 may be followed by block 915.

At block 915, a first bucket index of the source-destination tuple may be determined based on a hash value of the source-destination tuple. Block 915 may be followed by block 920.

At block 920, it may be determined whether a slot corresponding to the first bucket index is occupied in a first-level hash table. If it is determined that a slot corresponding to the first bucket index is occupied in a first-level hash table, block 920 may be followed by block 925, else block 920 is followed by block 950.

At block 925, a second bucket index of the source-destination tuple is calculated. Block 925 may be followed by block 930.

At block 930, it may be determined if a slot corresponding to the second bucket index is occupied in a second-level hash table. If it is determined that a slot corresponding to the second bucket index is occupied in a second-level hash table, block 930 may be followed by block 935, else block 930 may be followed by block 950.

At block 935, a walk may be performed of the second-level hash table to locate the source-destination tuple. In some implementations, locating the source-destination tuple may include retrieving a particular source-destination tuple associated with the slot corresponding to the second bucket index as the reference source-destination tuple. Block 935 may be followed by block 940.

At block 940, it may be determined whether the source-destination tuple was located (found) in the second-level hash table. If it is determined that the source-destination tuple was located in the second-level hash table, block 940 may be followed by block 945, else block 940 may be followed by block 950.

At block 945, it is determined that the source-destination tuple matches a reference source-destination tuple. For example, in some implementations, it may be determined if the source-destination tuple and the reference source-destination tuple are identical. If the source-destination tuple and the reference source-destination tuple are identical, it may be determined that the source-destination tuple matches the reference source-destination tuple. Accordingly, a corresponding rule for processing the traffic associated with the source-destination tuple may be implemented, e.g., accept the packet data traffic for onward transmission and/or other packet processing.

At block 950, it may be determined that the source-destination tuple does not match any reference source-destination tuple. In some implementations, the traffic associated with non-matching tuples may be dropped (rejected) at the network layer itself, without further processing.

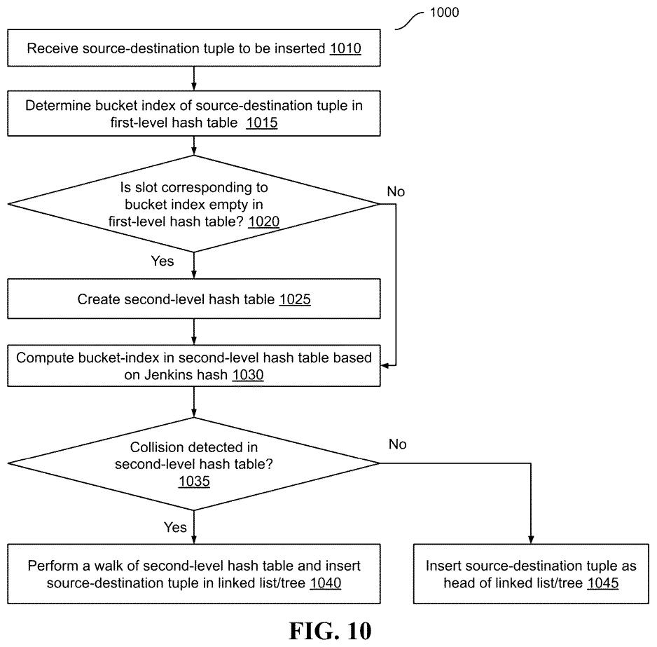

FIG. 10 illustrates an example method for insertion of a source-destination tuple into a hash table, according to some embodiments described herein.

Method 1000 may be performed to insert a source-destination tuple into a hash table, e.g., when a new VPN tunnel has been established, and a source-destination tuple corresponding to the new VPN tunnel is to be added to a tuple store. Method 1000 may begin at block 1010.

At block 1010, the source-destination tuple to be inserted is received (obtained). Block 1010 may be followed by block 1015.

At block 1015, a bucket index of the source-destination tuple in a first-level hash table is determined. Block 1015 may be followed by block 1020.

At block 1020, it is determined if a slot corresponding to the bucket index is empty in the first-level hash table, or whether it is occupied. If it is determined that the slot corresponding to the bucket index is empty in the first-level hash table, block 1020 may be followed by block 1025, else block 1020 may be followed by block 1030.

At block 1025, a second-level hash table is created (generated). Block 1025 may be followed by block 1030.

At block 1030, a bucket-index in the second-level hash table is computed based on a Jenkins hash function. Block 1030 may be followed by block 1035.

At block 1035, it is determined whether a collision (e.g., when two different source-destination tuples map to the same hash value (or index) within the second-level hash table) is detected in the second-level hash table. If it is determined that a collision is detected in the second-level hash table, block 1035 may be followed by block 1040, else block 1035 may be followed by block 1045.

At block 1040, a walk may be performed of the second-level hash table and the source-destination tuple is inserted in the linked list/tree.

At block 1045, the source-destination tuple may be inserted at the head of a linked list/tree.

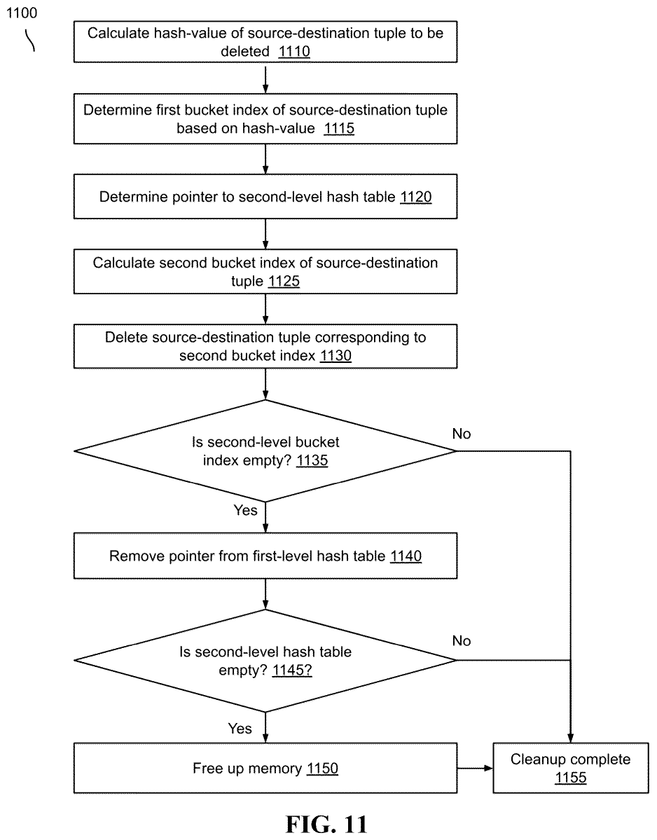

FIG. 11 illustrates an example method for deletion of a source-destination tuple from a hash table, according to some embodiments described herein.

Method 1100 may be performed to delete a source-destination tuple from a hash table, e.g., when an existing VPN tunnel is to be taken down, and a source-destination tuple corresponding to the VPN tunnel is to be deleted from a tuple store. Method 1100 may begin at block 1110.

At block 1110, a hash-value of the source-destination tuple to be deleted from the tuple store is calculated. Block 1110 may be followed by block 1115.

At block 1115, a first bucket index of the source-destination tuple is determined based on the hash-value of the source-destination tuple. Block 1115 may be followed by block 1120.

At block 1120, a pointer to the second-level hash table is determined based on the first bucket index. Block 1120 may be followed by block 1125.

At block 1125, a second bucket index of the source-destination tuple is determined. Block 1125 may be followed by block 1130.

At block 1130, the source-destination tuple corresponding to the second bucket index may be located in the second hash-table and deleted. Block 1130 may be followed by block 1135.

At block 1135, it may be determined if the second-level bucket index is empty (after the deletion). If it is determined that the second-level bucket index is empty, block 1135 may be followed by block 1140, else block 1135 may be followed by block 1155.

At block 1140, the pointer from the first-level hash table is removed. Block 1140 may be followed by block 1145.

At block 1145, it may be determined if the second-level hash table is empty. If it is determined that the second-level hash table is empty, block 1145 may be followed by block 1150, else block 1145 may be followed by block 1155.

At block 1150, memory may be freed up. Block 1150 may be followed by block 1155.

At block 1155, the cleanup operation of the hash tables is considered to be completed.

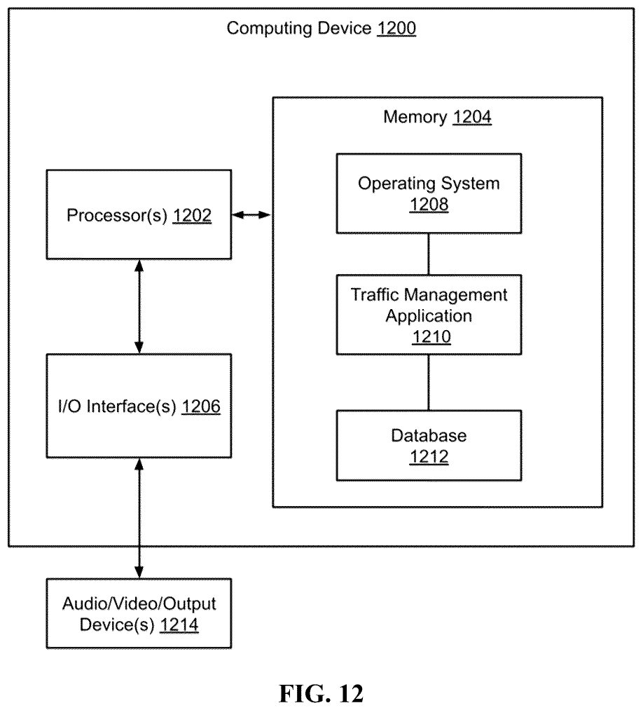

FIG. 12 is a block diagram of an example computing device, according to some embodiments described herein.

FIG. 12 is a block diagram of an example computing device 1200 which may be used to implement one or more features described herein, in accordance with some implementations. In one example, device 1200 may be used to implement a computer device, (e.g., firewall 10 of FIGS. 1-2), and perform appropriate method implementations described herein. Computing device 1200 can be any suitable computer system, server, or other electronic or hardware device. For example, the computing device 1200 can be a mainframe computer, desktop computer, workstation, portable computer, or electronic device (portable device, mobile device, cell phone, smart phone, tablet computer, television, TV set top box, personal digital assistant (PDA), media player, game device, wearable device, etc.). In some implementations, device 1200 includes a processor 1202, a memory 1204, input/output (I/O) interface 1206, and audio/video input/output devices 1214 (e.g., display screen, touchscreen, display goggles or glasses, audio speakers, microphone, etc.).

Processor 1202 can be one or more processors and/or processing circuits to execute program code and control basic operations of the device 1200. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 1204 is typically provided in device 1200 for access by the processor 1202, and may be any suitable processor-readable storage medium, e.g., random access memory (RAM), read-only memory (ROM), Electrical Erasable Read-only Memory (EEPROM), Flash memory, etc., suitable for storing instructions for execution by the processor, and located separate from processor 1202 and/or integrated therewith. Memory 1204 can store software operating on the server device 1200 by the processor 1202, including an operating system 1208, a security application or computer program product 1210, and a database 1212.

Memory 1204 can include software instructions for executing the operations as described with reference to FIGS. 1-11. Any software in memory 1204 can alternatively be stored on any other suitable storage location or computer-readable medium. In addition, memory 1204 (and/or other connected storage device(s)) can store instructions and data used in the features described herein. Memory 1204 and any other type of storage (magnetic disk, optical disk, magnetic tape, or other tangible media) can be considered “storage” or “storage devices.”

I/O interface 1206 can provide functions to enable interfacing the server device 1200 with other systems and devices. For example, network communication devices, storage devices (e.g., memory and/or data store 116), and input/output devices can communicate via interface 1206. In some implementations, the I/O interface can connect to interface devices including input devices (keyboard, pointing device, touchscreen, microphone, camera, scanner, etc.) and/or output devices (display device, speaker devices, printer, motor, etc.).

For ease of illustration, FIG. 12 shows one block for each of processor 1202, memory 1204, I/O interface 1206, software blocks 1208, and 1210, and database 1212. These blocks may represent one or more processors or processing circuitries, operating systems, memories, I/O interfaces, applications, and/or software modules. In other implementations, device 1200 may not have all of the components shown and/or may have other elements including other types of elements instead of, or in addition to, those shown herein.

A user device can also implement and/or be used with features described herein. Example user devices can be computer devices including some similar components as the device 1200, e.g., processor(s) 1202, memory 1204, and I/O interface 1206. An operating system, software and applications suitable for the client device can be provided in memory and used by the processor. The I/O interface for a user device can be connected to network communication devices, as well as to input and output devices, e.g., a microphone for capturing sound, a camera for capturing images or video, audio speaker devices for outputting sound, a display device for outputting images or video, or other output devices. A display device within the audio/video input/output devices 1214, for example, can be connected to (or included in) the device 1200 to display images, where such display device can include any suitable display device, e.g., an LCD, LED, or plasma display screen, CRT, television, monitor, touchscreen, 3-D display screen, projector, or other visual display device. Some implementations can provide an audio output device, e.g., voice output or synthesis that speaks text.

The methods, blocks, and/or operations described herein can be performed in a different order than shown or described, and/or performed simultaneously (partially or completely) with other blocks or operations, where appropriate. Some blocks or operations can be performed for one portion of data and later performed again, e.g., for another portion of data. Not all of the described blocks and operations need be performed in various implementations. In some implementations, blocks and operations can be performed multiple times, in a different order, and/or at different times in the methods.

In some implementations, some or all of the methods can be implemented on a system such as one or more user devices, servers, and threat management facilities. In some implementations, one or more methods described herein can be implemented, for example, on a server system with a dedicated threat management facility, and/or on both a server system and any number of threat management facilities. In some implementations, different components of one or more servers and or user devices can perform different blocks, operations, or other parts of the methods.

One or more methods described herein (e.g., methods 700, 800, 900, 1000, and/or 1100) can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g. Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating systems.

Although the description has been described with respect to particular implementations thereof, these particular implementations are merely illustrative, and not restrictive. Concepts illustrated in the examples may be applied to other examples and implementations.

Note that the functional blocks, operations, features, methods, devices, and systems described in the present disclosure may be integrated or divided into different combinations of systems, devices, and functional blocks as would be known to those skilled in the art. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

The above systems, devices, methods, processes, and the like may be realized in hardware, software, or any combination of these suitable for a particular application. The hardware may include a general-purpose computer and/or dedicated computing device. This includes realization in one or more microprocessors, microcontrollers, embedded microcontrollers, programmable digital signal processors or other programmable devices or processing circuitry, along with internal and/or external memory. This may also, or instead, include one or more application specific integrated circuits, programmable gate arrays, programmable array logic components, or any other device or devices that may be configured to process electronic signals. It will further be appreciated that a realization of the processes or devices described above may include computer-executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. In another aspect, the methods may be embodied in systems that perform the steps thereof, and may be distributed across devices in a number of ways. At the same time, processing may be distributed across devices such as the various systems described above, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

Embodiments disclosed herein may include computer program products comprising computer-executable code or computer-usable code that, when executing on one or more computing devices, performs any and/or all of the steps thereof. The code may be stored in a non-transitory fashion in a computer memory, which may be a memory from which the program executes (such as random-access memory associated with a processor), or a storage device such as a disk drive, flash memory or any other optical, electromagnetic, magnetic, infrared, or other device or combination of devices. In another aspect, any of the systems and methods described above may be embodied in any suitable transmission or propagation medium carrying computer-executable code and/or any inputs or outputs from the same.

The method steps of the implementations described herein are intended to include any suitable method of causing such method steps to be performed, consistent with the patentability of the following claims, unless a different meaning is expressly provided or otherwise clear from the context. So, for example, performing the step of X includes any suitable method for causing another party such as a remote user, a remote processing resource (e.g., a server or cloud computer) or a machine to perform the step of X. Similarly, performing steps X, Y and Z may include any method of directing or controlling any combination of such other individuals or resources to perform steps X, Y and Z to obtain the benefit of such steps. Thus, method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity, and need not be located within a particular jurisdiction.

It will be appreciated that the methods and systems described above are set forth by way of example and not of limitation. Absent an explicit indication to the contrary, the disclosed steps may be modified, supplemented, omitted, and/or re-ordered without departing from the scope of this disclosure. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context. Thus, while particular embodiments have been shown and described, it will be apparent to those skilled in the art that various changes and modifications in form and details may be made therein without departing from the spirit and scope of this disclosure and are intended to form a part of the invention as defined by the following claims, which are to be interpreted in the broadest sense allowable by law.

What is claimed is:

1. A computer-implemented method, comprising:
receiving data traffic at a network device from an endpoint device over a virtual private network (VPN) tunnel established between the endpoint device and the network device, wherein the data traffic includes a source-destination tuple that comprises a source gateway IP address and a destination gateway IP address;
determining, at a network layer of the network device, whether the source-destination tuple matches a reference source-destination tuple of a plurality of reference source-destination tuples, wherein individual reference source-destination tuples comprise a respective reference source gateway IP address and a respective reference destination gateway IP address;
based on a determination that the source-destination tuple matches the reference source-destination tuple, accepting the data traffic for onward transmission to a protocol layer of the network device; and
based on a determination that the source-destination tuple does not match any reference source-destination tuple, rejecting the data traffic at the network layer of the network device.

2. The computer-implemented method of claim 1, wherein determining whether the source-destination tuple matches the reference source-destination tuple comprises:
computing a hash value based on the source-destination tuple, wherein the hash value is unique to the source-destination tuple; and
performing a search of the plurality of reference source-destination tuples based on the hash value.

3. The computer-implemented method of claim 2, wherein performing the search of the plurality of reference source-destination tuples based on the hash value of the source-destination tuple comprises:
determining a first bucket index of the source-destination tuple based on the hash value;
determining if a slot corresponding to the first bucket index is occupied in a first-level hash table;
if it is determined that the slot corresponding to the first bucket index is not occupied, determining that the source-destination tuple does not match any reference source-destination tuple; and
if it is determined that the slot corresponding to the first bucket index is occupied:
calculating a second bucket index of the source-destination tuple;
determining if a slot corresponding to the second bucket index is occupied in a second-level hash table;
if it is determined that the slot corresponding to the second bucket index is not occupied in the second-level hash table, determining that the source-destination tuple does not match any reference source-destination tuple; and
if it is determined that a slot corresponding to the second bucket index is occupied,
retrieving a particular source-destination tuple associated with the slot corresponding to the second bucket index as the reference source-destination tuple; and
determining if the source-destination tuple and the reference source-destination tuple are identical;
if the source-destination tuple with the reference source-destination tuple are identical, determining that the source-destination tuple matches the reference source-destination tuple; and
if the source-destination tuple with the reference source-destination tuple are not identical, determining that the source-destination tuple does not match any reference source-destination tuple.

4. The computer-implemented method of claim 1, further comprising, based on the determination that the source-destination tuple matches the reference source-destination tuple, forwarding the data traffic to the protocol layer of the network device, wherein the forwarding is performed without network address translation.

5. The computer-implemented method of claim 1, further comprising prior to receiving the data traffic from the endpoint device, generating a tuple store at the network device that includes the plurality of reference source-destination tuples based on a source gateway IP address and a destination gateway IP address associated with one or more virtual private network (VPN) tunnels established at a protocol layer of the network device.

6. The computer-implemented method of claim 5, further comprising issuing an iptables command based on an ipset list that includes a respective source IP address and destination IP address associated with the one or more VPN tunnels.

7. The computer-implemented method of claim 1, further comprising establishing a VPN tunnel by performing an internet key exchange (IKE) negotiation between the endpoint device and the network device.

8. The computer-implemented method of claim 1, wherein determining whether the source-destination tuple matches a reference source-destination tuple comprises executing a kernel level process that performs a comparison of a hash of the source-destination tuple with respective hashes of the plurality of reference source-destination tuples.

9. A system comprising:
one or more processors coupled to a computer-readable medium having stored thereon software instructions that, when executed by the one or more processors, cause the one or more processors to perform operations comprising:
receiving data traffic at a network device from an endpoint device over a virtual private network (VPN) tunnel established between the endpoint device and the network device, wherein the data traffic includes a source-destination tuple that comprises a source gateway IP address and a destination gateway IP address;
determining, at a network layer of the network device, whether the source-destination tuple matches a reference source-destination tuple of a plurality of reference source-destination tuples, wherein individual reference source-destination tuples comprise a respective reference source gateway IP address and a respective reference destination gateway IP address;
based on a determination that the source-destination tuple matches the reference source-destination tuple, accepting the data traffic for onward transmission to a protocol layer of the network device; and
based on a determination that the source-destination tuple does not match any reference source-destination tuple, rejecting the data traffic at the network layer of the network device.

10. The system of claim 9, wherein determining whether the source-destination tuple matches the reference source-destination tuple comprises:
computing a hash value based on the source-destination tuple, wherein the hash value is unique to the source-destination tuple; and
performing a search of the plurality of reference source-destination tuples based on the hash value.

11. The system of claim 10, wherein performing the search of the plurality of reference source-destination tuples based on the hash value of the source-destination tuple comprises:
determining a first bucket index of the source-destination tuple based on the hash value;
determining if a slot corresponding to the first bucket index is occupied in a first-level hash table;
if it is determined that the slot corresponding to the first bucket index is not occupied, determining that the source-destination tuple does not match any reference source-destination tuple; and
if it is determined that the slot corresponding to the first bucket index is occupied:
calculating a second bucket index of the source-destination tuple;
determining if a slot corresponding to the second bucket index is occupied in a second-level hash table;
if it is determined that the slot corresponding to the second bucket index is not occupied in the second-level hash table, determining that the source-destination tuple does not match any reference source-destination tuple; and
if it is determined that a slot corresponding to the second bucket index is occupied,
retrieving a particular source-destination tuple associated with the slot corresponding to the second bucket index as the reference source-destination tuple; and
determining if the source-destination tuple and the reference source-destination tuple are identical;
if the source-destination tuple with the reference source-destination tuple are identical, determining that the source-destination tuple matches the reference source-destination tuple; and
if the source-destination tuple with the reference source-destination tuple are not identical, determining that the source-destination tuple does not match any reference source-destination tuple.

12. The system of claim 9, wherein the operations further comprise:
based on the determination that the source-destination tuple matches the reference source-destination tuple, forwarding the data traffic to the protocol layer of the network device, wherein the forwarding is performed without network address translation.

13. The system of claim 9, wherein the operations further comprise:
prior to receiving the data traffic from the endpoint device, generating a tuple store at the network device that includes the plurality of reference source-destination tuples based on a source gateway IP address and a destination gateway IP address associated with one or more virtual private network (VPN) tunnels established at a protocol layer of the network device.

14. The system of claim 13, wherein the operations further comprise issuing an iptables command based on an ipset list that includes a respective source IP address and destination IP address associated with the one or more VPN tunnels.

15. The system of claim 9, wherein the operations further comprise establishing a VPN tunnel by performing an internet key exchange (IKE) negotiation between the endpoint device and the network device.

16. The system of claim 9, wherein determining whether the source-destination tuple matches a reference source-destination tuple comprises executing a kernel level process that performs a comparison of a hash of the source-destination tuple with respective hashes of the plurality of reference source-destination tuples.

17. A non-transitory computer-readable medium having stored thereon software instructions that, when executed by one or more processors, cause the one or more processors to perform operations comprising:
receiving data traffic at a network device from an endpoint device over a virtual private network (VPN) tunnel established between the endpoint device and the network device, wherein the data traffic includes a source-destination tuple that comprises a source gateway IP address and a destination gateway IP address;
determining, at a network layer of the network device, whether the source-destination tuple matches a reference source-destination tuple of a plurality of reference source-destination tuples, wherein individual reference source-destination tuples comprise a respective reference source gateway IP address and a respective reference destination gateway IP address;
based on a determination that the source-destination tuple matches the reference source-destination tuple, accepting the data traffic for onward transmission to a protocol layer of the network device; and
based on a determination that the source-destination tuple does not match any reference source-destination tuple, rejecting the data traffic at the network layer of the network device.

18. The non-transitory computer-readable medium of claim 17, wherein determining whether the source-destination tuple matches the reference source-destination tuple comprises:
computing a hash value based on the source-destination tuple, wherein the hash value is unique to the source-destination tuple; and
performing a search of the plurality of reference source-destination tuples based on the hash value.

19. The non-transitory computer-readable medium of claim 18, wherein performing the search of the plurality of reference source-destination tuples based on the hash value of the source-destination tuple comprises:
determining a first bucket index of the source-destination tuple based on the hash value;
determining if a slot corresponding to the first bucket index is occupied in a first-level hash table;
if it is determined that the slot corresponding to the first bucket index is not occupied, determining that the source-destination tuple does not match any reference source-destination tuple; and
if it is determined that the slot corresponding to the first bucket index is occupied:
calculating a second bucket index of the source-destination tuple;
determining if a slot corresponding to the second bucket index is occupied in a second-level hash table;
if it is determined that the slot corresponding to the second bucket index is not occupied in the second-level hash table, determining that the source-destination tuple does not match any reference source-destination tuple; and
if it is determined that a slot corresponding to the second bucket index is occupied,
retrieving a particular source-destination tuple associated with the slot corresponding to the second bucket index as the reference source-destination tuple; and
determining if the source-destination tuple and the reference source-destination tuple are identical;
if the source-destination tuple with the reference source-destination tuple are identical, determining that the source-destination tuple matches the reference source-destination tuple; and
if the source-destination tuple with the reference source-destination tuple are not identical, determining that the source-destination tuple does not match any reference source-destination tuple.

20. The non-transitory computer-readable medium of claim 17, wherein the operations further comprise:
prior to receiving the data traffic from the endpoint device, generating a tuple store at the network device that includes the plurality of reference source-destination tuples based on a source gateway IP address and a destination gateway IP address associated with one or more virtual private network (VPN) tunnels established at a protocol layer of the network device.
